(19) United States
(12) Patent Application Publication
(10) Pub. No.: US 2014/0189579 A1
(43) Pub. Date: Jul. 3, 2014

(54) SYSTEM AND METHOD FOR CONTROLLING ZOOMING AND/OR SCROLLING

(71) Applicant: ZRRO TECHNOLOGIES (2009) LTD., Tel Aviv (IL)

(72) Inventors: Ori RIMON, Tel Aviv (IL); Rafi ZACHUT, Rishon Le'zion (IL)

(73) Assignee: ZRRO TECHNOLOGIES (2009) LTD., Tel Aviv (IL)

(21) Appl. No.: 14/146,041

(22) Filed: Jan. 2, 2014

Related U.S. Application Data
(60) Provisional application No. 61/748,373, filed on Jan. 2, 2013.

(51) Int. Cl. G06F 3/0485

(52) U.S. Cl. CPC G06F 3/0485
USPC 715/784

(57) ABSTRACT

The present invention is aimed at a system and a method for instructing a computing device to perform zooming actions, for example on a picture (enlarging and reducing the size of a virtual object on a display) and scrolling actions (e.g. sliding text, images, or video across a display, vertically or horizontally) in an intuitive way, by using a controller which can detect the distance between an object (e.g. the user's finger) and a surface defined by a sensing system.

### TECHNOLOGICAL FIELD

The present invention is in the field of computing, and more particularly in the field of controlling devices for manipulating virtual objects on a display, such as object tracking devices and pointing devices.

### BACKGROUND

Users use controlling devices (user interfaces) for instructing a computing device to perform desired actions. Such controlling devices may include keyboards and pointing devices. In order to enhance the user-friendliness of computing devices, the computing industry has been making efforts to develop controlling devices which track the motion of the user's body parts (e.g. hands, arms, legs, etc.) and are able to convert this motion into instructions to computing devices. Moreover, special attention has been dedicated to developing gestures which are natural to the user, for instructing the computing device to perform the desired actions. In this manner, the user's communication with the computer is eased, and the interaction between the user and the computing device seems so natural to the user that the user does not feel the presence of the controlling device.

Patent publications WO 2010/084498 and US 2011/0279397, which share the inventors and the assignee of the present patent application, relate to a monitoring unit for use in monitoring a behavior of at least a part of a physical object moving in the vicinity of a sensor matrix.

### General Description

The present invention is aimed at a system and a method for instructing a computing device to perform zooming actions, for example on a picture (enlarging and reducing the size of a virtual object on a display) and scrolling actions (e.g. sliding text, images, or video across a display, vertically or horizontally) in an intuitive way, by using a controller which can detect the distance between an object (e.g. the user's finger) and a surface defined by a sensing system.

In this connection, it should be understood that some devices such as, as described for example in U.S. Pat. No. 7,844,915, have been developed in which gesture operations includes performing a scaling transform such as a zoom in or zoom out in response to a user input having two or more input points. Moreover, in this technique, a scroll operation is related to a single touch that drags a distance across a display of the device. However, it should be understood that there is need for a continuous control of a zooming/scrolling mode by using three-dimensional sensor ability.

More specifically, in some embodiments of the present invention, there is provided a zoom/scroll control module configured to recognize gestures corresponding to the following instructions: zoom in and zoom out, and/or scroll up and scroll down. The zoom/scroll control module may also be configured for detecting gestures corresponding to the following actions: enter zooming/scrolling mode, and exit zooming/scrolling mode. Upon recognition of the gestures, the zoom/scroll control module outputs appropriate data to a computing device, so as to enable the computing device to perform the actions corresponding to the gestures.

There is provided a system for instructing a computing device to perform zooming/scrolling actions. The system comprises a sensor system generating measured data being indicative of a behavior of an object in a three-dimensional space and a zoom/scroll control module associated with at least one of the sensor system and a monitoring unit configured for receiving the measured data. The zoom/scroll control module is configured for processing data received by at least one of the sensor system and the monitoring unit, and is configured for recognizing gestures and, in response to these gestures, outputting data for a computing device so as to enable the computing device to perform zooming and/or scrolling actions. The sensor system comprises a surface being capable of sensing an object hovering above the surface and touching the surface.

In some embodiments, the monitoring module is configured for transforming the measured data into cursor data indicative of an approximate representation of at least a part of the object in a second virtual coordinate system.

In some embodiments, at least one of the monitoring module and zoom/scroll control module is configured to differentiate between hover and touch modes.

In some embodiments, the gesture corresponding to zooming in or scrolling up involves touching the surface with a first finger and hovering above the surface with a second finger. Conversely, the gesture corresponding to zooming out or scrolling down involves touching the surface with the second finger and hovering above the surface with the first finger. The zoom/scroll control module may thus be configured for analyzing the measured data and/or cursor data to determine whether the user has performed a gesture for instructing the computing device to perform zooming or scrolling actions.

In some embodiments, the zoom/scroll control module is configured for identifying entry/exit condition(s) by analyzing at least one of the cursor data and the measured data.

In some embodiments, the zoom/scroll control module is configured for processing the at least one of measured data and cursor data to determine the direction of the zoom or scroll and generating an additional control signal instructing the computing device to analyze output data from the zoom/scroll module and extract therefrom an instruction relating to the direction of the zoom or scroll, to thereby control the direction of the zoon or scroll. Additionally, the zoom/scroll control module is configured for processing the at least one of measured data and cursor data to determine the speed of the zoom or scroll and generating an additional control signal instructing the computing device to analyze output data from the zoom/scroll module and extract therefrom an instruction relating to the speed of the zoom or scroll, to thereby control the speed of the zoom or scroll.

In some embodiments, the zoom/scroll control module instructs the computing device to zoom/scroll when one finger is touching the sensor system and one finger is hovering above the sensor system.

In some embodiments, the zoom/scroll control module determines the direction of the scroll/zoom according to the position of a hovering finger relative to a touching finger.

In some embodiments, the zoom/scroll control module is configured for correlation between the rate/speed at which the zooming or scrolling is done and the height of the hovering finger above the surface. For example, the higher the hovering finger is above the surface, the higher is the rate/speed of the zooming or scrolling action.

In some embodiments, if while in zooming/scrolling mode, the hovering finger goes above the maximal detection height of the sensor system, the zoom/scroll module identifies this height as the maximal detection height.

In some embodiments, the zoom/scroll control module is configured for receiving and processing at least one of the measured data and cursor data indicative of an approximate representation of at least a part of the object in a second virtual coordinate system from the monitoring module.

There is also provided a method for instructing a computing device to perform zooming/scrolling actions. The method comprises providing measured data indicative of a behavior of a physical object with respect to a predetermined sensing surface; the measured data being indicative of the behavior in a three-dimensional space; processing the measured data indicative of the behavior of the physical object with respect to the sensing surface for identifying gestures and, in response to these gestures, outputting data for a computing device so as to enable the computing device to perform zooming and/or scrolling actions.

In some embodiments, the method comprises processing the measured data and transforming it into an approximate representation of the at least a part of the physical object in a virtual coordinate system. The transformation maintains a positional relationship between virtual points and corresponding portions of the physical object; and further processing at least the approximate representation.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a block diagram illustrating a system of the present invention, configured for recognizing gestures and, in response to these gestures, outputting data for a computing device so as to enable the computing device to perform zooming and/or scrolling actions;

FIGS. 2a and 2b are schematic drawings illustrating some possible gestures recognized as instructions to zoom/scroll in different directions;

FIG. 3 is a flowchart illustrating a method for controlling the zooming of a computing device, according to some embodiments of the present invention;

FIG. 4 is a schematic drawing illustrating an example of the sensor system of the present invention being a proximity sensor system of the present invention, having a sensing surface defined by crossing antennas and an enlarged drawing illustrating the sensing element(s) of a proximity sensor;

FIG. 5 is a flowchart illustrating a method of the present invention for using the proximity sensor system of FIG. 4 to recognize an entry condition to the zooming/scrolling mode and an exit condition from the zooming/scrolling mode;

FIG. 6 is a flowchart illustrating a method of the present invention for using the proximity sensor system of FIG. 4 to recognize gestures which are used by the user as instructing to zoom/scroll, and to output data enabling the computing device to perform zooming or scrolling actions;

FIGS. 7a-7e are schematic drawings and charts illustrating different conditions recognizable by the zoom control module, according to data received by the proximity sensor system of FIG. 4, while performing the method of FIG. 5, according to some embodiments of the present invention;

FIGS. 8a and 8b are schematic drawings and charts illustrating different conditions recognizable by the zoom control module, according to data received by the proximity sensor system of FIG. 4, while performing the method of FIG. 6, according to some embodiments of the present invention;

FIGS. 9a-9c are schematic drawings illustrating an example of data output to the computing device, while out of zooming/scrolling mode (9a) and while in zooming/scrolling mode (9b-9c); and

FIG. 10 is a schematic drawing illustrating an example of a proximity sensor system of the present invention, having a sensing surface defined by a two-dimensional array of rectangular antennas (pads), and an enlarged drawing illustrating the sensing element(s) of a proximity sensor.

### DETAILED DESCRIPTION OF EMBODIMENTS

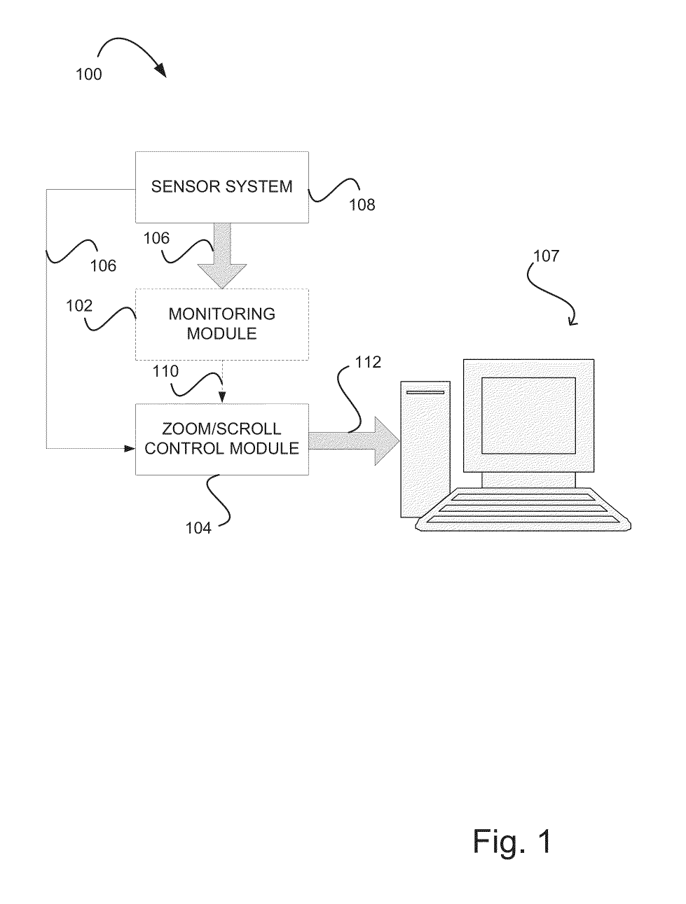

Referring now to the drawings, FIG. 1 is a block diagram illustrating a system 100 of the present invention for instructing a computing device to perform zooming/scrolling actions. The system 100 includes a zoom/scroll control module 104 and a sensor system 108 generating a measured data being indicative of a behavior of an object in a three-dimensional space. The zoom/scroll control module 104 is configured for recognizing gestures and, in response to these gestures, outputting data 112 for a computing device so as to enable the computing device to perform zooming and/or scrolling actions. The sensor system 108 includes a surface (for example a sensing surface), and is capable of sensing an object hovering above the surface and touching the surface. It should be noted that the sensor system 108 of the present invention may be made of transparent material.

In some embodiments, the system 100 comprises a monitoring module 102 in wired or wireless communication with a sensor system 108, being configured to receive input data 106 (also referred to as measured data) generated by the sensor system 108. The measured data 106 is indicative of a behavior of an object in a first coordinate system defined by the sensor system 108. The monitoring module 102 is configured for transforming the measured data 106 into cursor data 110 indicative of an approximate representation of the object (or parts of the object) in a second (virtual) coordinate system. The cursor data 110 refers hereinafter to measurements of the x, y, and z coordinates of a user's fingers which controls the position of the cursor(s) and its image attributes (size, transparency etc.), and two parameters zL and zR indicative of the height of left and right fingertips, respectively. The second coordinate system may be, for example, defined by a display associated with computing device. The monitoring module 102 is configured to track and estimate the 3D location of the user's finger as well as differentiate between hover and touch modes. Alternatively or additionally, the zoom/scroll control module is also configured to differentiate between hover and touch modes.

The cursor data 110 is meant to be transmitted in a wired or wireless fashion to the computing device via the zoom/scroll control module 104. The computing device may be a remote device or a device integral with system 100. The cursor data 110 enables the computing device to display an image of at least one cursor on the computing device's display and move the image in the display's virtual coordinate system. For example, the cursor data 110 may be directly fed to the computing device's display, or may need a formatting/processing within the computing device before being readable by the display. Moreover, the cursor data 110 may be used by a software utility (application) running on the computing device to recognize a certain behavior corresponding to certain action defined by the software utility, and execute the certain action. The action may, for example, include activating/manipulating virtual objects on the computing device's display.

Before reaching the computing device, the cursor data 110 is transmitted in a wired or wireless fashion to the zoom/scroll control module 104. The zoom/scroll control module 104 is configured for analyzing the input data 106 from the sensor system 108 and/or cursor data 110 to determine whether the user has performed a gesture for instructing the computing device to perform zooming or scrolling actions. To do this, the zoom/scroll control module 104 may need to establish whether the user wishes to start zooming or scrolling. If the zoom/scroll control module 104 identifies, in the cursor data 110 or in the input data 106, an entry condition which indicates that the user wishes to enter zooming/scrolling mode, the zoom/scroll control module 104 generates output data 112 which includes instructions to zoom or scroll. This may be done by at least one of: (i) forming the output data 112 by adding a control signal to the cursor data 110, where the control signal instructs the computing device to use/process the cursor data 110 in a predetermined manner and extract therefrom zooming or scrolling instructions; or (ii) manipulating/altering the cursor data 110 to produce suitable output data 112 which includes data pieces indicative of instructions to zoom or scroll. In this manner, by receiving this output data 112, the computing device is able to perform zooming or scrolling in the direction desired by the user. If, on the contrary, the zoom/scroll control module 104 does not identify the entry condition or identifies an exit condition (indicative of the user's wish to exit the zooming/scrolling mode), the zoom/scroll control module 104 enables the cursor data 110 to reach the computing device unaltered, in order to enable the computing device to control one or more cursors according to the user's wishes. Some examples of gestures corresponding to entry/exit conditions will be detailed further below.

In some embodiments, the speed/rate at which the zooming or scrolling is done is related to the height of the hovering finger above the surface. For example, the higher the finger, the higher is the rate/speed of the zooming or scrolling action. The zoom/scroll control module 104 is configured for (a) manipulating/altering the cursor data 110 by adding additional data pieces, relating to a speed of zoom or scroll or (b) generating an additional control signal instructing the computing device to analyze the cursor data 110 and extract therefrom an instruction relating to the speed of zoom or scroll. In this manner, the user is able to control both the direction and the speed of the zoom or scroll.

According to some embodiments of the present invention, when in zooming/scrolling mode, the cursor's image disappears. To implement this function, the zoom/scroll control module 104 may send a further control signal to the computing device, instructing the computing device to suppress the cursor's image on the display while in zooming/scrolling mode. Alternatively, the computing device is preprogrammed to suppress the cursor's image while in zooming/scrolling mode, and does not need a specific instruction to do so from the zoom/scroll control module 104.

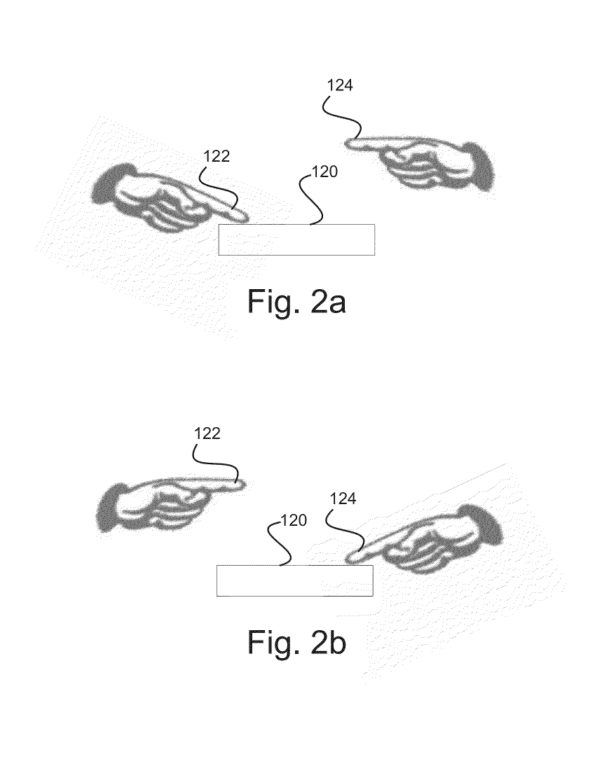

In a non-limiting example, some gestures performed by the user to zoom in or scroll up are shown in FIG. 2a. A first (e.g. left) region of the sensor system's surface 120 is touched by one finger 122, while another finger 124 hovers above the second (e.g. right) region of the sensor system surface 120 in order to zoom out or scroll up. Conversely, in order to zoom out or scroll down, the user is to hover over the first (e.g. left) region of the sensor system's surface 120 with one finger 122 and touch the second (e.g. right) region of the sensor system surface 120 with another finger 124, as illustrated in FIG. 2b. It should be noticed that this is only an example, and the opposite arrangement can be also used, i.e. touching the right region of the surface while hovering over the left region of the surface in order to zoom out or scroll up, and touching the left region of the surface while hovering over the right region of the surface in order to zoom out or scroll down. It should also be noted that when the sensor system surface 120 is touched by the fingers 122 and 124 simultaneously, no zooming and/or scrolling actions are performed. Additionally, when both fingers 122 and 124 hover over the sensor system surface 120, no zooming and/or scrolling actions are performed.

According to a similar arrangement, rather than determining the direction of the zoom/scroll depending on whether the touching finger is on the right or left of the hovering finger, the direction of the zoom/scroll is determined depending on whether the touching finger is in front of or behind the hovering finger.

Also is should be noted that, while in zooming/scrolling mode only one of scrolling and zooming occurs. In some embodiments of the present invention, once zooming/scrolling mode is entered, the computing device is programmed to implement zooming or scrolling according to the context. For example, if a web page is displayed, then scrolling is implemented; if a photograph is displayed, then zooming is implemented. In other embodiments, the implementation of zooming or scrolling is determined by the application being used. For example, if the application is a picture viewer, then zooming is implemented. Conversely, if the application is a word processing application or a web browser, then scrolling is implemented. In a further variant, the computing device is programmed for being capable of only one of zooming and scrolling in response the output data 112 outputted by the zoom/scroll control module 104.

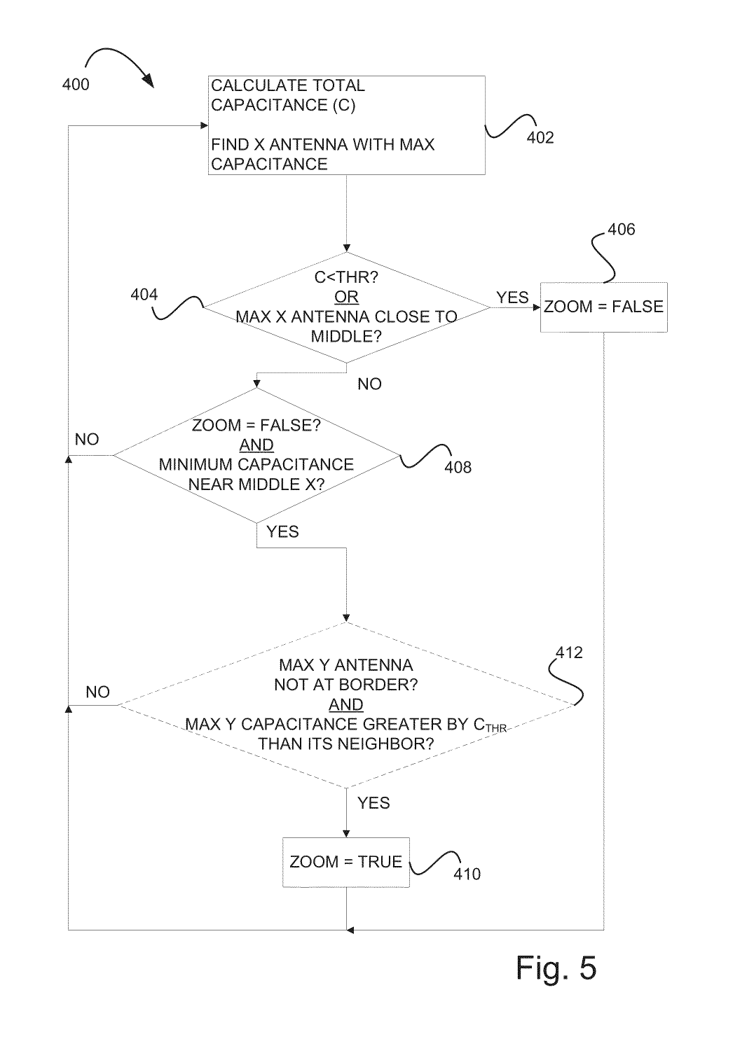

In some embodiments, the entry/exit condition can be identified when the user performs predefined gestures. The predefined gesture for entering zooming/scrolling mode may include, for example, touching the sensor system's surface on both regions at the same time, or (if the sensor is in a single-touch mode i.e. only one finger is used to control one cursor) introducing a second finger within the sensing region of the sensor system (as will be explained in detail in the description of FIG. 5). The gesture for exiting the zooming/scrolling mode may include, for example, removing the two fingers from the sensing region of the sensor system, or removing one or two of the fingers to a third (e.g. middle) region between the first and second regions of the surface. As will be exemplified, the entry/exit conditions intuitively fit the start/end of the zoom/scroll operation in a way that the user might not even be aware that the system has changed its mode of operation to controlling zooming/scrolling.

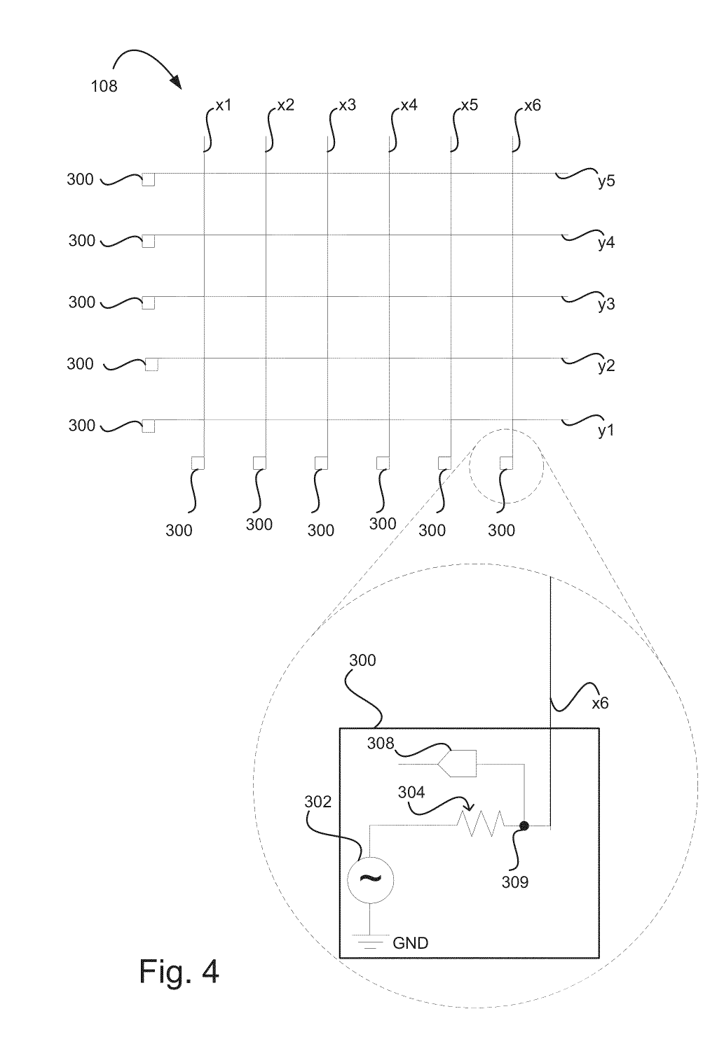

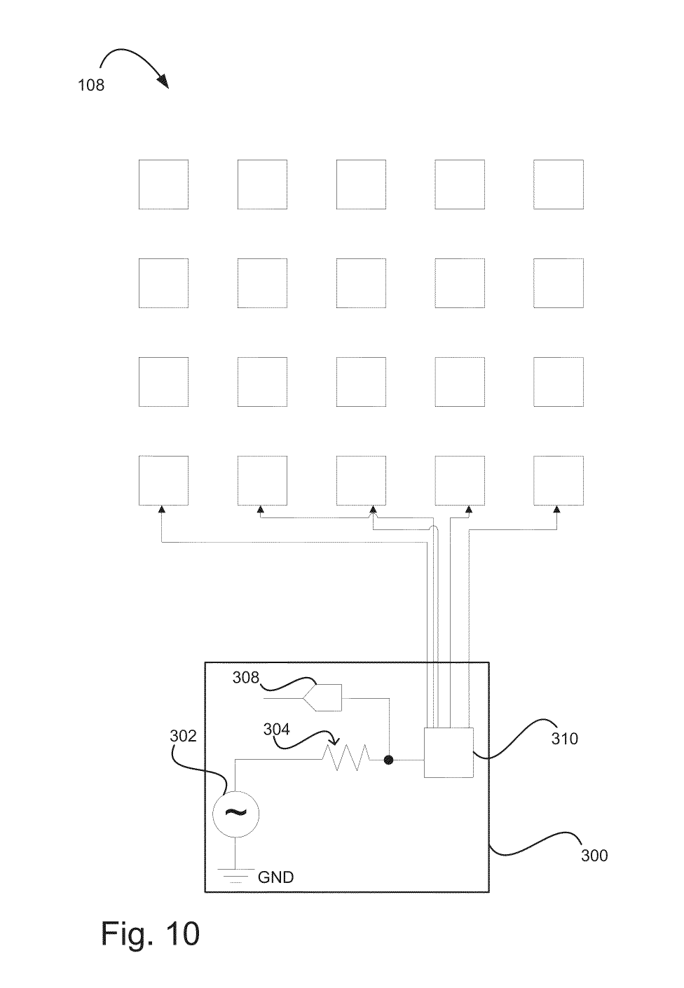

In some embodiments, the sensor system 108 may be any system that can allow recognizing the presence of two fingers and generate data regarding the height of each finger (i.e. the distance of each finger from the surface). The sensor system 108 may therefore include a capacitive sensor matrix having a sensing surface defined by crossing antennas connected as illustrated in FIG. 4, or a capacitive sensor matrix having a sensing surface defined by a two dimensional array of rectangular antennas (pads) as illustrated in FIG. 10. The latter sensor matrix is described in patent publications WO 2010/084498 and US 2011/0279397, which share the inventors and the assignee of the present patent application.

In a variant, the sensor system 108 may include an acoustic sensor matrix having a sensing surface defined by a two-dimensional array of transducers, as known in the art. In this example, the transducers are configured for generating acoustic waves and receiving the reflections of the generated waves, to generate measured data indicative of the position of the finger(s) hovering over or touching the sensing surface.

In another variant, the sensor system 108 may include an optical sensor matrix (as known in the art) having a sensing surface defined by a two-dimensional array of emitters of electromagnetic radiation and sensors for receiving light scattered/reflected by the finger(s), so as to produce measured data indicative of the position of the fingers(s).

In a further variant, the sensor system 108 may include one or more cameras and an image processing utility. The camera(s) is (are) configured for capturing images of finger(s) with respect to a reference surface, and the image processing utility is configured to analyze the images to generate data relating to the position of the finger(s) (or hands) with respect to the reference surface.

It should be noted that, in some embodiments, the touching of the surface defined by the sensor system is equivalent to the touching of a second surface associated with the first surface defined by the sensor system. For example, the first surface (e.g. sensing surface or reference surface as described above) may be protected by a cover representing the second surface, to prevent the object from touching directly the first surface. In this case, the object can only touch the outer surface of the protective cover. The outer surface of the protective cover is thus the second surface associated with the surface defined by the sensor system.

It should be noted that in one variant, the monitoring module 102 and the zoom/scroll control module 104 may be physically separate units in wired or wireless communication with each other and having dedicated circuitry for performing their required actions. In another variant, the monitoring module 102 and the zoom/scroll control module 104 are functional elements of a software package configured for being implemented on one or more common electronic circuits (e.g. processors). In a further variant, the monitoring module 102 and the zoom/scroll control module 104 may include some electronic circuits dedicated to individual functions, some common electronic circuits for some or all the functions and some software utilities configured for operating the dedicated and common circuits for performing the required actions. In yet a further variant, the monitoring module 102 and the zoom/scroll control module 104 may perform their actions only via hardware elements, such as logic circuits, as known in the art.

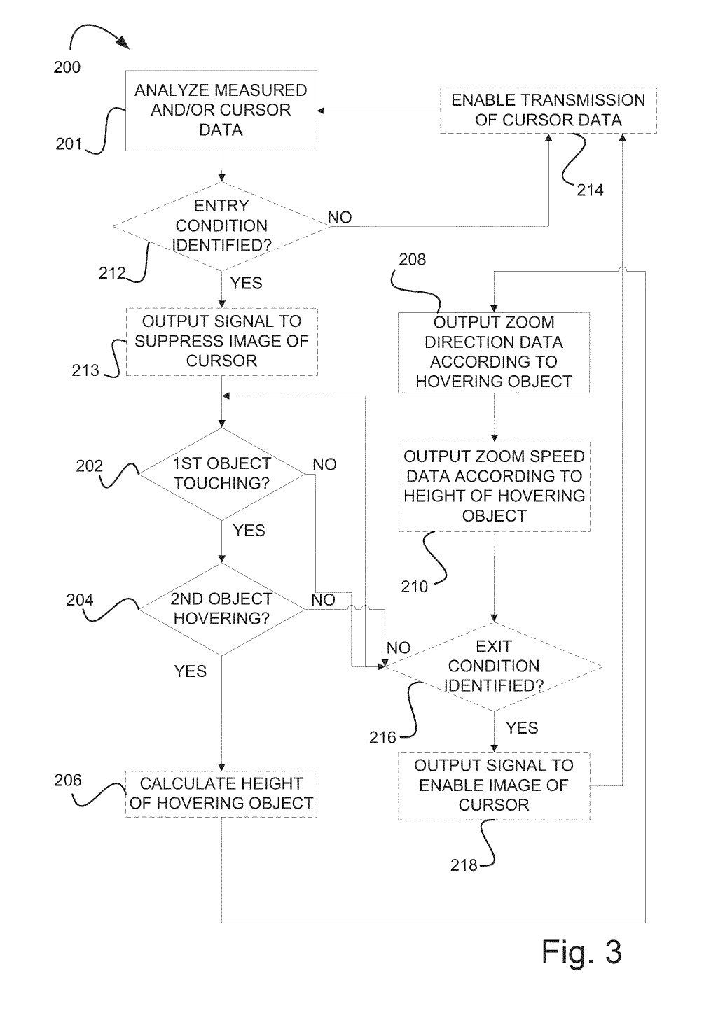

Referring now to FIG. 3, flowchart 200 illustrates a method for controlling the zooming of a computing device, according to some embodiments of the present invention. The method of the flowchart 200 is performed by the zoom/scroll module 104 of FIG. 1. It should be noticed that while method illustrated in the flowchart 200 relates to the control of zoom, the same method can be used for controlling scrolling.

The method of the flowchart 200 is a control loop, where each loop corresponds to a cycle defined by the hardware and or software which performs the method. For example, a cycle can be defined according to the rate at which the sensor measurements (regarding all the antennas) are refreshed. This constant looping enables constant monitoring of the user's finger(s) for quickly identifying the gestures corresponding to entry/exit condition.

At 201, measured data 106 from the sensor system 108 and/or cursor data 110 from the monitoring module 102 is/are analyzed to determine whether entry condition to zooming/scrolling mode exists.

At 202, after zooming/scrolling mode is entered, a check is made to determine whether one object (finger) is touching the surface of the sensor system. If no touching occurs, the check is made at 216 to determine whether an exit condition indicative of the user's gesture to exit zooming/scrolling mode is identified in the cursor data 110 and/or the measured data 106. After the touch is identified, a second check is made at 204 to check whether a second object is hovering above the surface of the sensor system 108. If no hovering object is detected, then a check is made at 216 to determine whether an exit condition indicative of the user's gesture to exit zooming/scrolling mode is identified in the cursor data 110 and/or the measured data 106. If the hovering object is detected, optionally the height of the hovering object relative to the sensor system's surface is calculated at 206.

At 208, output data is generated by the zoom/scroll control module 104. As mentioned above, the output data (112 in FIG. 1) (i) may include the cursor data (110, in FIG. 1) and a control signal, where the control signal instructs the computing device to use/process cursor data 110 so as to extract therefrom zooming instructions, or (ii) may include the cursor data 110 manipulated/altered to include a data piece indicative of the location of the touching object relative to the hovering object. This output data 112 determines whether zoom in or zoom out is implemented. Thus, by receiving the output data 112, the computing system is able to implement zooming in the desired direction.

In a non-limiting example, if the output data includes a data piece (which may be present in the original cursor data or in the altered cursor data) declaring that the touching object is to the left of the hovering object (FIG. 2a), then the computing device is programmed to implement zoom in. Conversely, if the output data includes a data piece declaring that the touching object is to the right of the hovering object (FIG. 2b), then the computing device is programmed to implement zoom out. As mentioned above, the direction of the zoom may be determined depending on whether the touching object is in front of or behind the hovering object.

Optionally, the zooming occurs at a predetermined fixed speed/rate. Alternatively, the zooming speed is controllable. In this case, at 210, additional output data indicative of the zoom speed is generated by the zoom/scroll control module 104. The additional output data may include (a) the cursor data 110 and an additional data piece indicative of the height of the hovering object calculated at 206, or (b) the cursor data 110 and an additional control signal configured for instructing the computing system to process the cursor data to extract instructions relating to the zoom speed. Thus, the computing system can process one or more suitable data pieces relating to the height of the hovering object (either included in the original cursor data 110 or added/modified by the zoom/scroll control module) to determine the speed of the zooming. Thus, the speed of the zooming is a function of the height of the hovering object. According to a non-limiting example, the zooming speed is a growing function of the hovering object's height.

It may be the case that, while in zooming/scrolling mode, the hovering object is raised over a threshold height, and the sensor system is no longer able to detect the hovering finger. According to some embodiments of the present invention, when the hovering finger is no longer sensed while in zooming/scrolling mode, the additional data piece outputted to the computing device still declares that the height of the hovering finger is at the threshold height. In this manner, the computing device keeps performing the zooming at the desired speed (which may be a constant speed or a function of height, as mentioned above), while the user does not need to be attentive to the sensing range of the sensing system.

From the steps 202 to 210, it can be seen that zooming occurs only when one object touches the sensor system's surface and one object hovers over the surface. Thus, while in zooming/scrolling mode, zooming does not occur if both objects touch the surface or if both objects hover over the surface.

As mentioned above, the zoom/scroll control module 104 of FIG. 1 is configured for determining entry to and exit condition from the zooming/scrolling mode. Thus, in some embodiments, prior to the check 202, a preliminary check may be made at 212 to determine whether an entry condition indicative of the user's gesture to enter zooming/scrolling mode is identified in the cursor data 110 and/or in the measured data 106. If the entry condition is not identified, transmission of unaltered cursor data to the computing device is enabled at 214, and the analysis of the measured and/or cursor data at 201 is repeated. If the entry condition is identified, the steps 202 to 210 are performed as described above, to instruct the computing device to perform zooming. Optionally, at 213, after the entry condition is identified, a signal is outputted to instruct the computing device to suppress the image of the cursor. Alternatively, this step is optional, as it may be implemented automatically by the computing device upon its entry to zooming/scrolling mode.

Optionally, after the data indicative of zoom direction (and optionally speed) is transmitted to the computing device at 208 (and 210, if applicable), a check is made at 216 to determine whether an exit condition indicative of the user's gesture to exit zooming/scrolling mode is identified in the cursor data 110 and/or the measured data 106. If the exit condition is identified, the transmission of unaltered cursor data to the computing device is enabled at 214, and the process is restarted. Optionally, if the image of the cursor was suppressed upon entry to zooming/scrolling mode, a signal is outputted at 218 to instruct the computing device to resume displaying an image of the cursor. This step may be unnecessary if the computing device is preprogrammed for resuming the display of the cursor's image upon receiving output data 112 indicative of an exit from zooming/scrolling mode. If no exit condition is identified, zooming/scrolling mode is still enabled, and the process is resumed from the check 202 to determine whether one object touches the sensor system's surface.

According to some embodiments of the present invention, the center of the zoom is the center of the image displayed on the display of the computing device prior to the identification of the entry condition. Alternatively, the center of the zoom is determined by finding the middle point of a line connecting the two fingers recognized at the entry condition, and by transforming the location of the middle point in the first coordinate system (of the sensor system) to a corresponding location in the second coordinate system on the display. The transformation of the middle point in the second coordinate system corresponds to the center of zoom. Generally, the computing device can be programmed to calculate and determine the center of zoom after receiving the coordinates of the two objects recognized when the entry condition is recognized. It should be noted that the expression “center of zoom” refers to a region of an image which does not change its location on the display when zooming occurs.

It should be noted that while the method of the flowchart 200 has been described as a method for controlling zooming, the same method can be implemented to control scrolling direction and (optionally) scrolling speed. The decision or capability to implement zooming or scrolling is usually on the side of the computing device as detailed above.

The following figures (FIGS. 4-6, 7a-7f, 8a-8b, and 9a-9b) relate to the use of measured data 106 from a particular sensor system to control zoom or scroll.

Referring now to FIG. 4, there is illustrated an example of a capacitive proximity sensor system 108 of the present invention, having a sensing surface defined by two sets of elongated antennas. It should be noted that the configuration described in FIG. 4 is particularly advantageous when the sensor size is small (e.g. having a diagonal of 2.5″). The sensor system 108 includes a sensing surface defined by a matrix formed by a first group of (horizontal) elongated antennas substantially (y1-y5) parallel to each other and a second group of (vertical) elongated antennas (x1-x6) substantially parallel to each other and at an angle with the antennas of the first group. Typically, the antennas of the first group are substantially perpendicular to the antennas of the second group. Though five horizontal antennas and six vertical antennas are present in the sensor system 108, these numbers are merely used as an example, and the sensor system 108 may have any number of horizontal and vertical antennas. Each antenna is connected to a sensing element or chip (generally, 300). As illustrated in the enlarged illustration, the sensing element 300 includes a circuit having a grounded power source 302 in series with a resistor 304. A measurement unit 308 (e.g. analog to digital converter) is connected to the resistor and is configured for measuring the signal at the junction 309. As a conductive object (such as the user's finger) is brought closer to the antenna x6, a capacitance between the object and the antenna is created, according to the well-known phenomenon of self-capacitance. The closer the finger to the antenna, the greater the equivalent capacitance measured on a virtual capacitor formed by the object and the antenna. The power source 302, which is electrically connected to the antenna x6, may be an AC voltage source. In such case, the greater the equivalent capacitance, the lesser the impedance it exerts, and the magnitude of the measured AC signal at junction 309 decreases as well (as known by voltage divider rule). Alternatively, the power source may excite DC current at the beginning of the measurement cycle. The greater the equivalent capacitance, the lesser the potential measured at the end of a fixed charge period. Optionally, in order to reduce the number of sensing elements, a switch is used to connect few antennas in sequential order to a single sensing element. Patent publications WO 2010/084498 and US 2011/0279397, which share the inventors and the assignee of the present patent application, describe in detail a sensing element similar to the sensing element 300, where the antenna is in the form of a sensing pad.

By measuring the voltage drop at junction 309, the equivalent capacitance of the virtual capacitor can be calculated. The equivalent capacitance (C) of the circuit decreases as the distance (d) between the user's finger and the antenna grows roughly according to the plate capacitor following formula:

d=A∈/C

where ∈ is a dielectric constant and A is roughly the overlapping area between the antenna and the conductive object.

In this connection, it should be understood that usually the sensor system 108 includes a parasitic capacitance which should be eliminated from the estimation of C above by calibration. Also, in order to keep fluent zoom control, the parameter d should be fixed at a maximum height for zoom control when C≈0, i.e. when the finger rises above the detection range of the sensor.

The sensor system 108 is generally used in the art for sensing a single object at a given time (referred as single touch mode). The capacitive proximity sensor system 108, however, can be used as a “limited multi-touch”, to sense two objects simultaneously, while providing incomplete data about the locations of the objects It should be understood that when two objects touch/hover simultaneously the sensor surface, the determination of the correlation between each x and y position for each object might be problematic. Notwithstanding the limitations of this kind of sensor, the “limited multi-touch” sensor can be used as an input to a system configured for controlling zooming/scrolling as described above. In fact, while the control of zooming/scrolling may require a precise evaluation of the distance between the sensor and one (hovering) finger, the exact positions along the sensing surface are not needed. Appropriately, via the analysis of measured data generated by the “limited multi-touch” sensor, the distances between the sensing surface and each of the objects can be calculated with satisfactory precision (for determining the speed of scroll/zoom), while the evaluation of the rest of the coordinates is imprecise.

The advantage of this kind of capacitive proximity sensor system as opposed to a sensor system having a two dimensional array of sensing elements (see FIG. 10) lies in the fact that in the “limited multi-touch” sensor less sensing elements are needed to cover a given surface. Since each sensing element needs certain energy to operate, the “limited multi-touch” sensor is more energy efficient. Moreover, the “limited multi-touch” sensor is cheaper, as it includes less sensing elements. It should also be noted that the entry condition should be more precise when using a sensor which allows for 3D detection of more than one finger (e.g. sensor having a two dimensional array). For example, the entry condition may correspond to detection of two fingertips touching the sensing surface for a predetermined amount of time. This is because in such sensor, tracking two fingers could be a common scenario and thus in order to avoid unintentional zooming/scrolling, a stronger condition is needed in order to enter to the zooming/scrolling mode.

To determine whether the user desires to maintain the zooming/scrolling mode, at least one of the following requirements should also be fulfilled: the touching finger is not near the middle of the sensing surface (useful especially in the case when a small sensor size is used); the fingers are sufficiently far apart from each other.

It should be noted that the gestures for entry to and exit from the zooming/scrolling mode are predefined gestures which can be clearly recognized by the zoom/scroll control module 104 with a high degree of accuracy, upon analysis of measured data 106 generated by the “limited multi-touch” sensor system 108 of FIG. 4. If this were not the case, conditions for entry to and exit from the zooming/scrolling mode could be erroneously recognized by the zoom/scroll control module 104 (e.g. because of noise or during simple finger movement), when the user does not wish to enter or exit the zooming/scrolling mode.

Referring now to FIG. 5, a flowchart 400 illustrates a method of the present invention for using the proximity sensor system of FIG. 4 to recognize an entry condition to and an exit condition from the zooming/scrolling mode.

Herein again, the method described in FIG. 5 is particularly advantageous when the sensor size is small (e.g. having a diagonal of 2.5″).

At 402, the sum of the equivalent capacitances of the antennas is calculated, and the vertical antenna having maximal equivalent capacitance is identified. In this connection, it should be noted that hereinafter, the equivalent capacitances of the antennas is generally referred as the equivalent capacitance of the virtual capacitor created by the antenna and an object as described above.

At 404, a check is made to determine (i) whether the sum of the equivalent capacitances of all antennas is less than a threshold or (ii) whether the vertical antenna having a maximal equivalent capacitance is close to the middle of the sensor. The threshold of condition (i) is chosen to indicate a state in which two fingers are clearly out of the sensing region of the sensor system. Thus, if condition (i) is true, the sensor has not sensed the presence of any finger within its sensing region and exit from zooming/scrolling mode is done. The identification of condition (ii) generally corresponds to the case in which a finger is near the middle of the sensing area, along the horizontal axis, which implies that the user has stopped controlling zoom (where the two fingers are at the edges of the horizontal axis) and wishes to have his finger tracked again. If either condition is true, no zooming/scrolling mode is to be implemented (406). After the lack of implementation of the zooming/scrolling mode, the process loops back to step 402.

Thus, if a zooming/scrolling mode is enabled before entering the check 404, and the check 404 is true, then the zooming/scrolling mode will be exited. If a zooming/scrolling mode is disabled before entering the check 404, and the check 404 is true, then the zooming/scrolling mode will be kept disabled. On the other hand, if a zooming/scrolling mode is enabled before entering the check 404, and the check 404 is false, the zooming/scrolling mode will be kept enabled. If a zooming/scrolling mode is disabled before entering the check 404, and the check 404 is false, the zooming/scrolling mode will be kept disabled.

If the check 404 is negative (neither condition is true), a second check is made at 408. In the check 408, it is determined whether (iii) the zooming/scrolling mode is disabled and (iv) whether the vertical antenna having minimal equivalent capacitance (compared to other vertical antennas) is near the middle. Referring to FIG. 4, condition (iv) is true if the antenna x3 or x4 has the lowest equivalent capacitance. Optionally, condition (iv) can be further limited (and thus strengthened) to determine whether the two vertical antennas having the lowest equivalent capacitance are near the middle. For example with reference to FIG. 4, condition (iv) might be true if both antennas x3 and x4 have the lowest equivalent capacitance. Condition (iv) ensures that two fingers are detected and that they are sufficiently far away from each other.

If one of conditions (iii) or (iv) is false, the process is restarted at step 402. If both conditions (iii) and (iv) are true, the process continues. Optionally, if both conditions (iii) and (iv) are true, the zooming/scrolling mode is enabled (410). Alternatively, before enabling the zooming/scrolling mode, a further check 412 is made.

At 412, one last check is made to determine (v) whether the horizontal antenna having maximal equivalent capacitance (compared to other horizontal antennas) is away from the edge of the sensing surface, and (vi) whether the horizontal antenna in (v) presents a capacitance greater by threshold as compared to one of its closest neighbors.

For the sensor of FIG. 4, condition (v) is true if antenna y1 and antenna y5 have not maximal equivalent capacitance among the horizontal antennas. Condition (v) is false, if one of antenna y1 or antenna y5 has the maximal equivalent capacitance among the horizontal antennas.

In some embodiments, conditions (v) and (vi) prevent entering zooming/scrolling mode unintentionally during other two fingers gestures (e.g. pinch). In some embodiments where other two fingers gestures could be applied (besides zoom/scroll), strengthening the zooming/scrolling mode entry condition (e.g. by condition (v) and (vi)) might be required, in order to prevent a case of unintentional entering to zooming/scrolling mode. As discussed above, the entry condition as well as the strengthening should intuitively fit the start of the zoom/scroll operation. In the case of conditions (v) and (vi), the fingers should be aligned roughly on the same Y coordinate close to the middle of the Y axis which suits the zoom controlling operation. If the check 412 is true, then zooming/scrolling mode is enabled. Otherwise, the process is restarted at step 402. After enabling the zooming/scrolling mode at 410, the process loops back to step 402. The method of the flowchart 400 is a control loop, where each loop corresponds to a cycle defined by the hardware and or software which performs the method. For example, a cycle can be defined according to the rate at which the sensor measurements (regarding all the antennas) are refreshed. This constant looping enables constant monitoring of the user's finger(s) for quickly identifying the gestures corresponding to entry/exit condition.

It should be noted that while the method of the flowchart 400 has been described for enabling or disabling the zooming mode, it can be used with no alterations to enable or disable the scrolling mode.

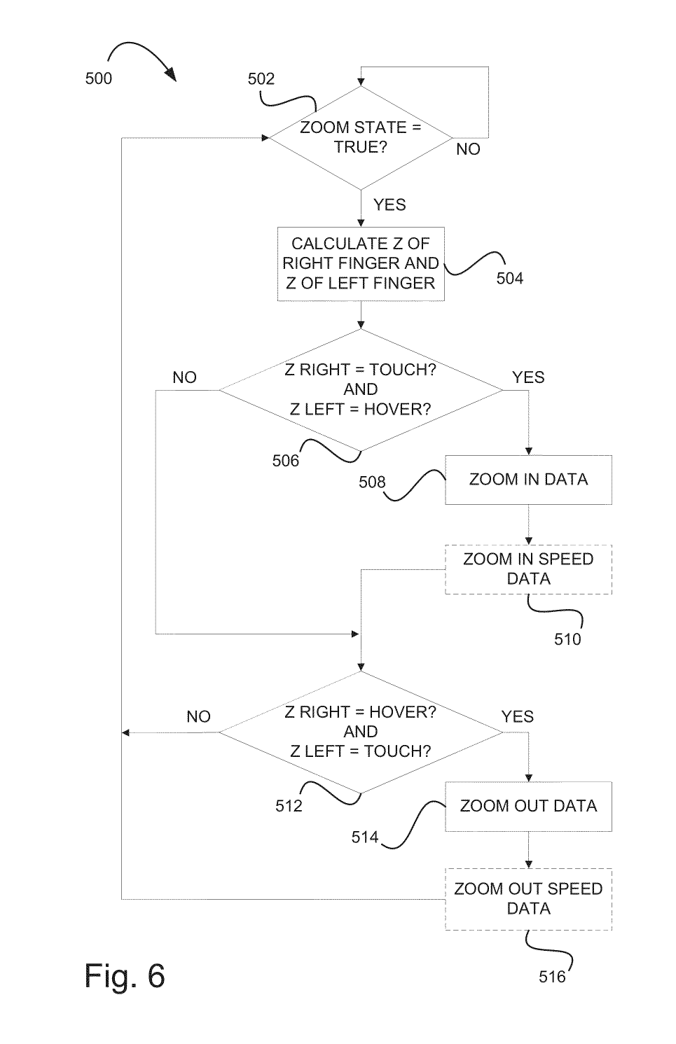

Referring now to FIG. 6, a flowchart 500 illustrates a method of the present invention for using the proximity sensor system of FIG. 4 to recognize gestures which are used by the user as instructions to zoom/scroll, and to output data enabling the computing device to perform zooming or scrolling actions.

At 502, a check is made to determine whether the zooming/scrolling mode is enabled. This check is made every cycle and corresponds to the method illustrated by the flowchart 400 of FIG. 5. If the zooming/scrolling mode is not enabled, the check is made again until the zooming/scrolling mode is enabled. If the zooming/scrolling mode is enabled, the process proceeds to the step 504.

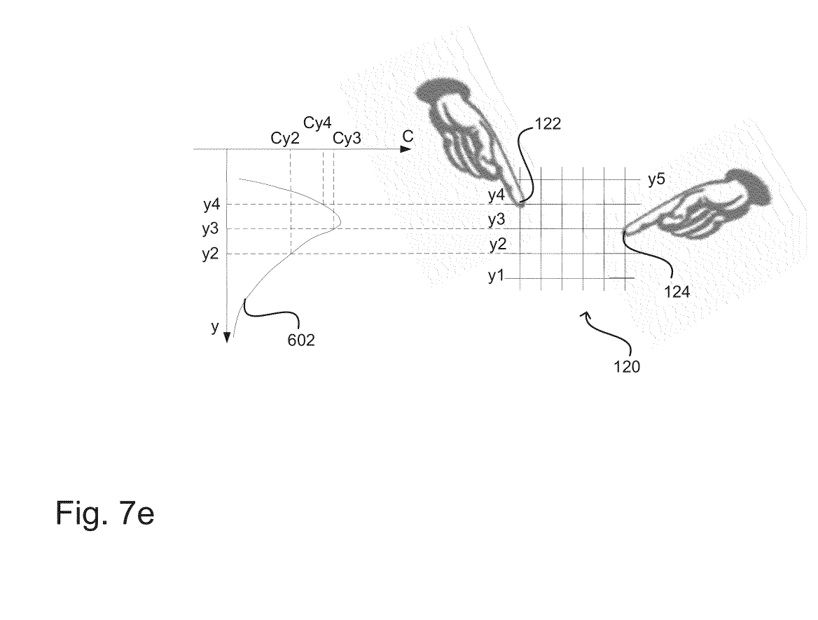

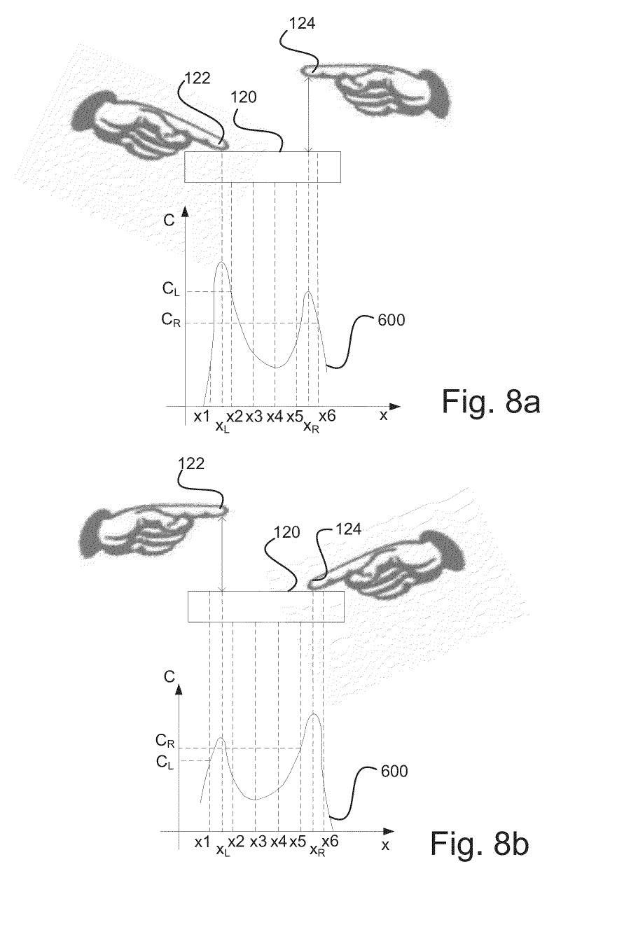

At 504, the height (Z) of the right finger and the left finger with respect to the sensing surface (or a second surface associated therewith) are calculated. The calculation of the height (Z) will be described in details below with respect to FIGS. 8a-8b. It should be noted that while such out-of plane distances can be calculated accurately, the exact coordinates along the plane of the sensing surface need not be calculated precisely, or even at all.

At 506, a check is made to determine whether the right finger touches the sensing surface while the left finger hovers above the sensing surface. If the check's output is positive, at 508 output data is generated by the zoom/scroll control module 104 of FIG. 1, to enable the computing device to implement a zoom-in action. Optionally, at 510 additional data is generated to enable the computing device to control the zoom speed according to the user's instructions (i.e. according to the distance between the hovering finger and the sensing surface).

If the check's output is negative, a further check is performed at 512. At 512, the check determines whether the left finger touches the sensing surface while the right finger hovers above the sensing surface. If the check's output is positive, at 514 output data is generated by the zoom/scroll control module 104 of FIG. 1, to enable the computing device to implement a zoom-out action. Optionally, at 516 additional data is generated to enable the computing device to control the zoom speed according to the user's instructions (i.e. according to the distance between the hovering finger and the sensing surface). If the output of the check 512 is negative, the process is restarted at 502.

It should be noted that when both fingers hover over the sensing surface or both finger touch the sensing surface, then no zooming is performed. Also, it should be noted that the method of the flowchart 500 can be performed for scroll control, by generating scroll up data at 508, scroll up speed data at 510, scroll down data at 514, and scroll down speed data at 516. The data is the same, and it generally is the computing device's choice on whether to use this data to implement zooming or scrolling.

The steps of the methods illustrated by the flowcharts 200, 400 and 500 of FIGS. 3, 5 and 6 may be steps configured for being performed by one or more processors operating under the instruction of software readable by a system which includes the processor. The steps of the method illustrated by the flowcharts 200, 400 and 500 of FIGS. 3, 5 and 6 may be steps configured for being performed by a computing system having dedicated logic circuits designed to carry out the above method without software instruction.

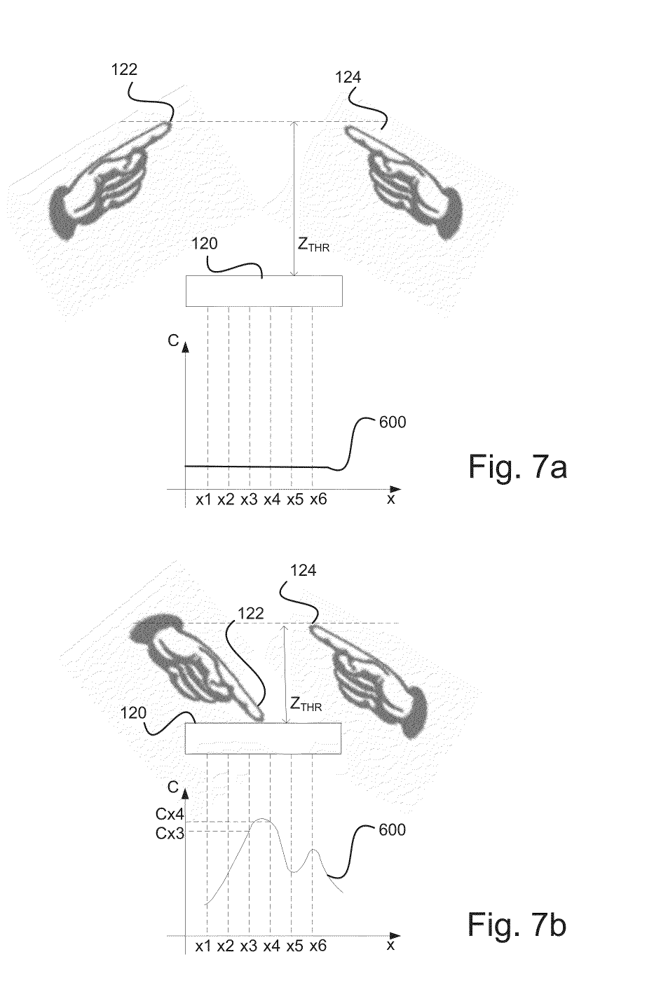

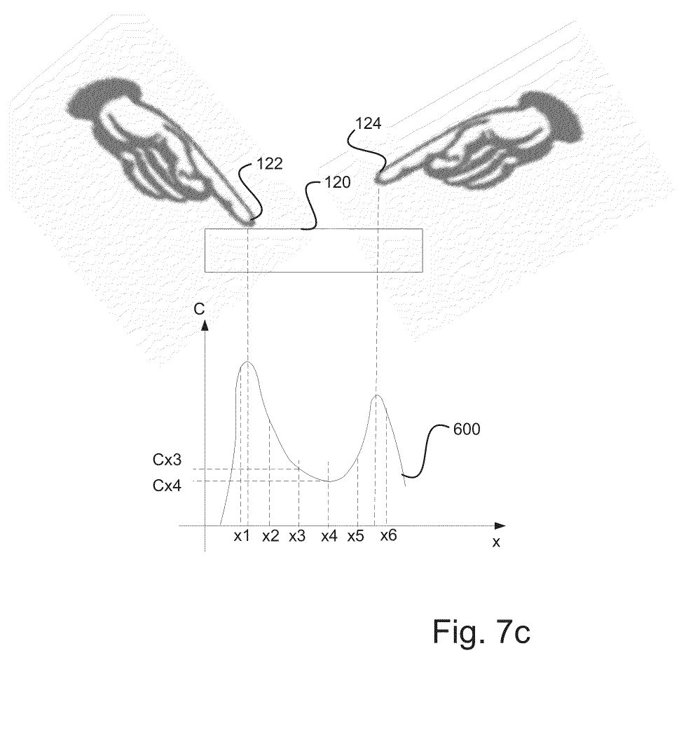

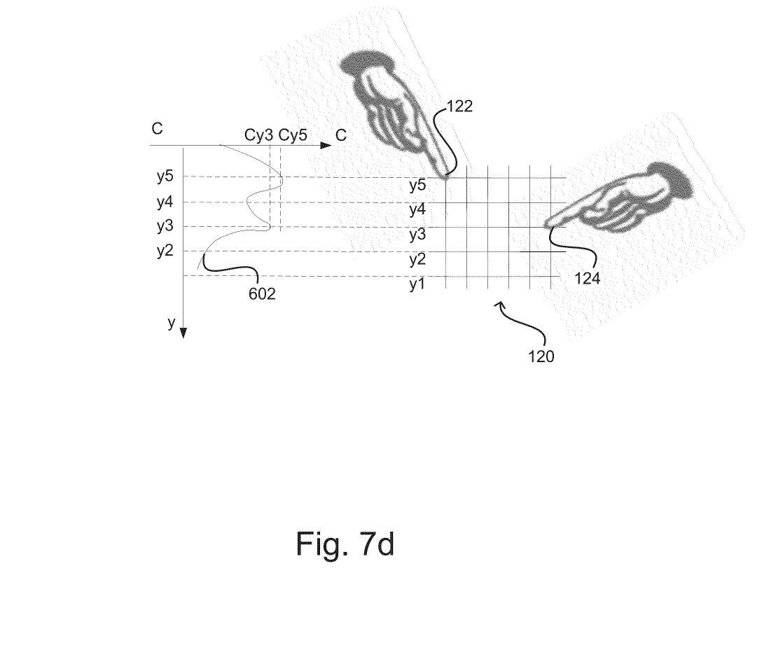

Referring now to FIGS. 7a-7e, schematic drawings and charts illustrate different conditions recognizable by the zoom control module, according to data received by the proximity sensor system of FIG. 4, while performing the method of FIG. 5. Herein again, the conditions described in FIGS. 7a-7e are particularly advantageous when the sensor size is small (e.g. having a diagonal of 2.5″).

In FIG. 7a, the left finger 122 and the right finger 124 are located above a threshold distance Z_{THR} from the surface 120 of the sensor system (shown from the side). Because the right finger and the left finger are distant from the surface 120, the equivalent capacitance of the antennas (x1-x6 in FIG. 4) is relatively small, as shown by the curve 600 indicating that no finger is placed in the sensing range of the sensor. The curve 600 is a theoretical curve representing the equivalent capacitance if it were measured by a sensor having infinitely many vertical antennas.

Thus the sum of the equivalent capacitances of the vertical antennas is below a threshold. The condition of FIG. 7a corresponds to the condition (i) in the check 404 in FIG. 5. The recognition of this condition is interpreted as an instruction not to implement (or to exit) the zooming/scrolling mode. It should be noted that this condition reflects a wish by the user to exit the zooming/scrolling mode since the gesture of clearing both fingers from the sensor is an intuitive gesture for exiting the zooming/scrolling mode.

In FIG. 7b, the left finger 122 and the right finger 124 are located below a threshold distance Z_{THR} from the surface 120 of the sensor system (shown from the side). Thus, the sum of the equivalent capacitances of the vertical antennas is above the threshold. However, the left finger 122 touch the surface 120 near the middle of the surface 120 along the horizontal axis. Thus antennas x3 and x4 have the highest equivalent capacitances (Cx3 and Cx4, respectively) when compared to the vertical antennas. Because x3 and x4 are the central antennas, the condition of FIG. 7b corresponds to the condition (ii) in the check 404 in FIG. 5. The recognition of this condition is interpreted as an instruction not to implement (or to exit) the zooming/scrolling mode. This condition may be used in the case that one finger is still above the sensing surface to return to navigation of a cursor image after the other one finger is not anymore above the sensing surface. The user wished to exit the zooming/scrolling mode and return to navigation without clearing both fingers from the sensor.

In FIG. 7c, the left finger 122 touches the sensing surface 120 near the leftmost antenna x1, while the right finger 124 hovers over the sensing surface 120 near the rightmost antenna x6. The central antennas x3 and x4 have the lowest equivalent capacitances. Thus the lowest measured equivalent capacitance is near the middle of the horizontal axis of the surface 120. This condition corresponds to the condition (iv) of the check 408 of FIG. 5. Generally, whenever the fingers are sufficiently far apart along the horizontal axis, the curve 600 has a concave shape near the middle. This shape generally satisfies the condition (iv), which may imply on the user wish to zoom/scroll

In FIG. 7d, the sensing surface 120 is viewed from above, to show the horizontal antennas (y1-y5). The left finger 122 touches the sensing surface 120 near the uppermost horizontal antenna y5, while the right finger 124 hovers above the sensing surface 120 near the central horizontal antenna y3. The curve 602 is a theoretical curve representing the equivalent capacitance if it were measured by a sensor having infinitely many horizontal antennas. In horizontal antenna y5, the equivalent capacitance Cy5 is greater than the equivalent capacitance in the other horizontal antenna. Thus, the condition (v) of the check 412 of FIG. 5 is not fulfilled, and zoom cannot be implemented. When a small sensor is used, this condition enables to prevent entering the zooming/scrolling mode during a pinch gesture.

In FIG. 7e, the left finger 122 touches the sensing surface 120 near the horizontal antenna y4, while the right finger 124 hovers above the sensing surface 120 near the central horizontal antenna y3. The sensing element having maximal equivalent capacitance Cy3 is not located near the horizontal borders of the sensing surface 120, this fulfilling condition (v) of the check 412 of FIG. 5. Also, the equivalent capacitance Cy3 is clearly larger that the equivalent capacitance Cy2 of its neighbor (horizontal antenna y2), thus fulfilling condition (vi) of the check 412 of FIG. 5. Although this requirement for strong maximum reduces the height at which entry to zooming/scrolling mode occurs, it eliminates unintentional entries to zooming/scrolling mode. Moreover, this reduced height is usually not noticeable by the user, as naturally he begins the zooming/scrolling by touching the sensor with two fingers.

Referring now to FIGS. 8a and 8b, schematic drawings and charts illustrate different conditions recognizable by the zoom control module, according to data received by the proximity sensor system of FIG. 4, while performing the method of FIG. 6, according to some embodiments of the present invention.

In FIG. 8a, while in zooming/scrolling mode, the user's left fingertip 122 touches the sensing surface 120 at a horizontal location x_{L} between the antennas x1 and x2, while the right fingertip 124 hovers over the sensing surface 120 at a horizontal location x_{R} between the antennas x5 and x6. In this case, the two highest local maxima of the equivalent capacitances measured by the sensor system belong to antennas x2 and x6. Thus, the equivalent capacitance C_{L} measured by the sensing element associated with the antenna x2 is defined as indicative of the height of the left fingertip, while the equivalent capacitance C_{R} measured by the sensing element associated with the antenna x6 is defined as indicative of the height of the right fingertip. The equivalent capacitance C_{L} is higher than a predetermined touch threshold, and therefore, a touch is recognized on the left side of the sensing surface. The equivalent capacitance C_{R} is lower than the predetermined touch threshold, and thus a hover is recognized over the right side of the sensing surface. This condition corresponds to an instruction to zoom out or scroll down, as shown in the step 512 of FIG. 6.

Alternatively the height of the left and right fingertips may be calculated according to the estimation of the equivalent capacitances at fixed antennas (e.g. x1 and x6).

In a non-limiting example the height of the left fingertip is calculated as follows:

zL=30000/(x1−errR+100)

and the height of the right fingertip is calculated as follows:

zR=30000/(x6−errL+100)

where errR is an estimation of the addition of capacitance to x1 caused by the right finger and errL is an estimation of the addition of capacitance to x6 caused by the left finger. It should be noted that errR and errL should be taken into account in particular when a small sensor is used in which the influence of each finger on both x1 and x6 is particularly significant.

The “+100” element in the denominator is intended to fix the height estimation at maximum height for zoom control when the equivalent capacitor (x1 for zL or x6 for zR) is very small, i.e. when a finger rises above the detection range of the sensor but the exit conditions from the zooming/scrolling mode are not fulfilled.

FIG. 8b is the opposite case of FIG. 8a, and corresponds to an instruction to zoom in or scroll up, as shown in the step 506 of FIG. 6. As mentioned above, FIGS. 8a and 8b are merely examples. Case may be that the condition of FIG. 8b corresponds to an instruction to zoom out or scroll down and that the condition of FIG. 8a corresponds to an instruction to zoom in or scroll up.

It should be noted that according to the method described in FIG. 6, the user may control zoom or scroll in two manners. In a first manner, the user touches the sensor's surface with a first fingertip while keeping a second fingertip hovering in order to implement zooming or scrolling, and removes the first fingertip from the sensor's surface to stop the zooming or scrolling. In a second manner, the user touches the sensor's surface with a first fingertip while keeping a second fingertip hovering in order to implement zooming or scrolling, and touches the sensor's surface with the second fingertip to stop the zooming or scrolling. In both manners, if speed control is available, the speed of zooming or scrolling can be controlled by the height of the hovering fingertips, while one of the fingertips touches the sensor's surface.

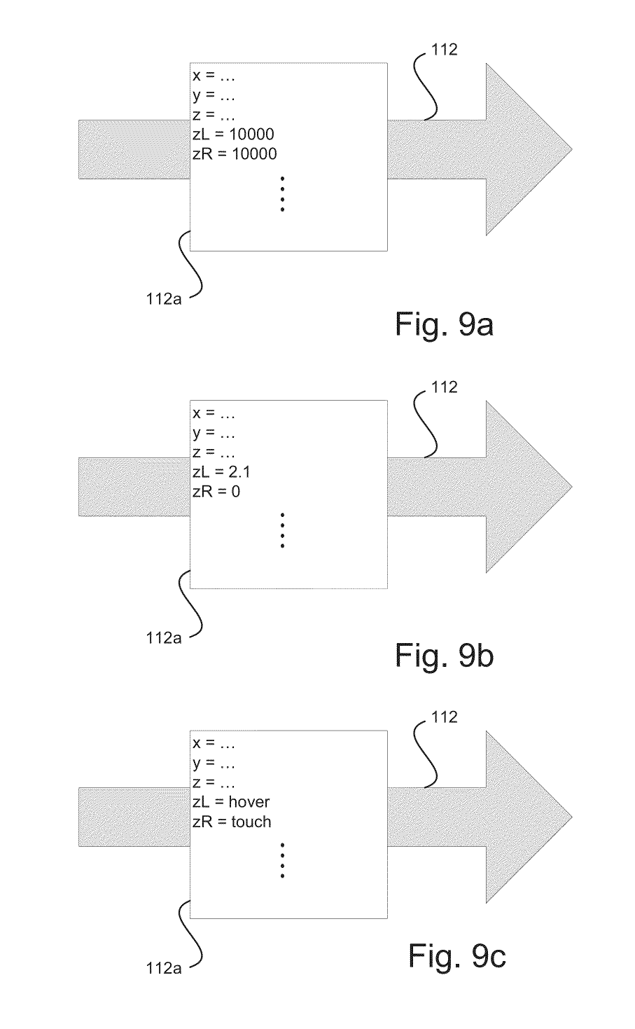

Referring now to FIGS. 9a-9c, schematic drawings illustrate an example of data output to the computing device, respectively, while out of zooming/scrolling mode and while in zooming/scrolling mode.

FIG. 9a represents an example of output data transmitted to the computing device while zooming/scrolling mode is disabled In FIG. 9a, zooming/scrolling mode is not enabled, and only one fingertip hovers or touches the sensor surface in a single-touch mode or in a “limited” multi-touch mode. The output data 112 to the computing device includes a table 112a, which includes measurements of the x, y, and z coordinates of the user's single fingertip which controls the position of the cursor, and two parameters zL and zR indicative of the height of left and right fingertips, respectively. When the zooming/scrolling mode is not enabled (i.e., before identification of the entry condition to the zooming/scrolling mode by the zoom/scroll control module 104 of FIG. 1, or after identification of the exit condition from the zooming/scrolling mode by the zoom/scroll control module 104 of FIG. 1), the zoom/scroll control module assigns specific values (e.g., 10000) to the zL and zR parameters. The computing device receiving these specific values for the zL and zR parameters knows to ignore such values and keeps presenting cursor according to the position of a single fingertip.

FIG. 9b represents an example of output data transmitted to the computing device while zooming/scrolling mode is enabled In FIG. 9b, after the zoom scroll module 104 of FIG. 1 recognizes the entry condition to the zooming/scrolling mode, the zoom/scroll control module assigns values to the zL and zR parameters indicative of the height of their corresponding fingertips over the sensor surface. As mentioned above, the heights zL and zR may be measured fairly accurately by the “limited multi-touch” system. When the computing device receives values of zL and zR different than the predetermined value (e.g. 10000), the computing device is configured for implementing the zooming/scrolling mode and using the zL and zR values for determining the direction of the zoom/scroll, and optionally the speed of the zoom/scroll. In this case, the computing device implements the flowchart 500 of FIG. 6, except for step 504 which is done by module 104.

FIG. 9c represents another example of output data transmitted to the computing device while the zooming/scrolling mode is enabled. In FIG. 9c, rather than assigning numeric values corresponding to an approximate height of the left and right fingertips, the zL and zR parameters are assigned two values which indicate whether the left and right fingertips touch the sensing/reference surface or hover over the sensing/reference surface. The value may be alphanumerical (e.g. “TOUCH” and “HOVER”) or binary (e.g. “0” corresponding to touch, “1” corresponding to hover). Again the values of the zL and zR parameters are different from the specific value (e.g. 10000), and the computing device knows to implement the zooming/scrolling mode in response to the output data 112. The output data 112 of FIG. 9c enables the computing device to determine the direction of the zoom/scroll, but not the speed of the zoom/scroll. In this case the computing device implements the flowchart 500 of FIG. 6, except for step 504.

In both the examples of FIG. 9b and FIG. 9c, if the values of zL and zR indicate that both fingertips touch the sensing/reference surface or that both fingertips hover over the sensing/reference surface, the zooming/scrolling mode is still enabled, but no zooming or scrolling is performed, as explained above.

Referring now to FIG. 10 a proximity sensor system is illustrated, having a sensing surface defined by a two-dimensional array/matrix of rectangular antennas (pads).

The proximity sensor system 108 of FIG. 10 is another example of a proximity sensor system that can be used in conjunction with the monitoring module 102 and zoom/scroll control module 104 of FIG. 1. The proximity sensor system 108 includes a two dimensional array/matrix of pads and capacitive sensing elements 300. The sensing elements 300 of FIG. 10 are similar to the sensing elements 300 of FIG. 4. As exemplified for few of the pads, a pad is connected via a switch 310 to a sensing element or chip (generally, 300) of the sensing surface. This kind of proximity sensor system is described in detail in patent publications WO 2010/084498 and US 2011/0279397, which share the inventors and the assignee of the present patent application. The sensor system of FIG. 10 is a full multi-touch system, which is capable (in conjunction with a suitable monitoring module) for tracking a plurality of fingertips at the same time and providing accurate x, y, z coordinates for each tracked fingertip. Thus, the entry and exit conditions for the zooming/scrolling mode may differ than the entry and exit conditions which suit the “limited multi-touch” sensor system of FIG. 4.

In some embodiments of the present invention, the entry condition corresponds to detection of two fingertips touching the sensing surface (or second surface associated therewith) of the sensor system 108 of FIG. 10 for a predetermined amount of time. Optionally, the exit condition corresponds to the lack of detection of any fingertip by the sensing surface, as explained above.

1. A system for instructing a computing device to perform zooming/scrolling actions, comprising:
a sensor system generating a measured data being indicative of a behavior of a plurality of objects in a three-dimensional space with respect to a predetermined sensing surface; and;
a zoom/scroll control module associated with at least one of said sensor system and a monitoring unit being configured for receiving said measured data;
wherein said zoom/scroll control module is configured for processing data received by at least one of said sensor system and said monitoring unit, and is configured for recognizing gestures and, in response to these gestures, outputting data for a computing device so as to enable the computing device to perform zooming and/or scrolling actions, wherein at least one object is hovering over the surface, said zoom/scroll control module determines the direction of the scroll/zoom according to the position of the hovering object relative to another object.

2. The system of claim 1, wherein said sensor system comprises a surface being capable of sensing an object hovering above the surface and touching the surface.

3. The system of claim 2, wherein at least one of said monitoring module and zoom/scroll control module is configured to differentiate between hover and touch modes.

4. The system of claim 1, wherein said monitoring module is configured for transforming said measured data into cursor data indicative of an approximate representation of at least a part of the object in a second virtual coordinate system.

5. The system of claim 4, wherein said zoom/scroll control module is configured for identifying entry/exit condition(s) by analyzing at least one of the cursor data and the measured data.

6. The system of claim 4, wherein said zoom/scroll control module is configured for processing said at least one of measured data and cursor data to determine a direction of the zoom or scroll and generating an additional control signal instructing the computing device to analyze an output data from said zoom/scroll module and extract therefrom an instruction relating to the direction of zoom or scroll, to thereby control the direction of zoom or scroll.

7. The system of claim 1, wherein said zoom/scroll control module instructs the computing device to zoom/scroll when one object is touching the sensor system and one object is hovering above the sensor system.

8. The system of claim 7, wherein said zoom/scroll control module determines the direction of the scroll/zoom according to the position of a hovering object relative to a touching object.

9. The system of claim 4, wherein said zoom/scroll control module is configured for processing said at least one of measured data and cursor data to determine a speed of the zoom or scroll and generating an additional control signal instructing the computing device to analyze an output data from said zoom/scroll module and extract therefrom an instruction relating to the speed of zoom or scroll, to thereby control the speed of zoom or scroll.

10. The system of claim 9, wherein said zoom/scroll control module is configured for correlation between at least one of a rate and a speed at which the zooming or scrolling is done and the height of the hovering object above the surface.

11. The system of claim 10, wherein when an object raises a certain height above a detection range of said sensor system, said zoom/scroll control module is configured for identifying said object height as a predetermined height threshold.

12. A method for instructing a computing device to perform zooming/scrolling actions comprising:
providing measured data indicative of a behavior of a plurality of physical object with respect to a predetermined sensing surface; said measured data being indicative of said behavior in a three-dimensional space;
processing said measured data indicative of the behavior of the physical object with respect to the sensing surface for identifying gestures and, in response to these gestures, outputting data for a computing device so as to enable the computing device to perform zooming and/or scrolling actions; and;
determining the direction of the scroll/zoom according to the position of one object relative to another object; wherein at least one object is hovering over the surface.

13. The method of claim 12, comprising processing said measured data and transforming it into an approximate representation of at least a part of the physical object in a virtual coordinate system, the transformation maintaining a positional relationship between virtual points and corresponding portions of the physical object; and further processing at least said approximate representation.

14. The method of claim 12, comprising instructing the computing device to zoom/scroll when one object is touching the sensing surface and one object is hovering above the sensing surface.

15. The method of claim 12, comprising correlating between at least one of a rate and a speed at which the zooming or scrolling is done and the height of the hovering object above the surface.
